(19) United States
(12) Patent Application Publication
(10) Pub. No.: US 2008/0014652 A1
(43) Pub. Date: Jan. 17, 2008

(54) Method and Apparatus for Introducing Samples of Gas at Controlled Pressure in a gas Chromatograph

(75) Inventor: Antonio Caprai, Livorno (IT)

Correspondence Address: DENNISON, SCHULTZ & MACDONALD, 1727 KING STREET, SUITE 105, ALEXANDRIA, VA, 22314, US

(73) Assignee: CNR CONSIGLIO NAZIONALE DELLE RICERCHE, Rome (IT)

(21) Appl. No.: 11/718,896

(22) PCT Filed: Jun. 3, 2005
(86) PCT No.: PCT/IB05/01568

§ 371 Date: Jun. 11, 2007

(30) Foreign Application Priority Data
Nov. 12, 2004 (IT) PI2004A000083

(51) Int. Cl. G01N 30/02; B01J 19/00

(52) U.S. Cl. 436/161; 422/89

(57) ABSTRACT

Apparatus for analysing a gas sample comprising a variable volume chamber (8) in fluodynamic connection through a line (21-22) with a sample holding container (30), in which the gas sample is contained, and through a line (11-19) with a plurality of gaschromatographic instruments, for example two (51, 52). These instruments carry out the quantitative and qualitative analysis of the gas sample according to known techniques. Preliminarily, by vacuum pumps (60), the line (11-23) and the variable volume chamber (8) are vacuumed. Then valves (41, 43, 45) are closed in order to exclude the portions of line set between valves (41, 43) and six-way valves (75, 76) respectively, and a delivery duct (23) of the pump (65), which is the general pumping means of the line. Since the variable volume chamber (8) is under vacuum when it is connected to the sample holding container (30), it attracts a certain quantity of gas sample inside. The pressure of the chamber (8), and then of the sample holding container (30), are monitored instantly by a pressure sensor (25), for example an analogic reader (35). Once chosen the column (51, 52) that can be used for carrying out the qualitative and quantitative analysis of the gas sample, the corresponding valve (41, 43) is open. Then, starting from a known volume and pressure, the gas sample is compressed, or expanded, changing the volume of the chamber (8), in order to bring the pressure of the gas same within a predetermined range of values for which the response of the detector (70, 71) is linear.

### FIELD OF THE INVENTION

The present invention relates to an apparatus for introducing gas to analyse into a gaschromatograph.

Furthermore, the invention relates to a method for gaschromatographic analysis that uses this apparatus.

### BACKGROUND OF THE INVENTION

As well known, a variety exists of types of analysis techniques where a mixture of gas is probed for determining its qualitative and quantitative composition. A common analysis technique is the so-called gaschromatographic analysis. It is used in research laboratories and in the field of quality control, such as the control of environment pollutants as well as for the analysis of food. The gaschromatographic technique is based on the principle that the many components of a gas mixture split themselves in a different way between two phases according to affinity with each phase. In the common gas gaschromatographic analysis the following are used: a steady phase, usually a solid or a gel that fills a chromatographic column, and a mobile phase, which is liquid or gaseous and brings the gas sample (solute) through the column. The steady phase is capable of delaying the flow of the many components in a differentiated way, either responsive to a distribution coefficient (between gas phase and liquid phase) or responsive to an adsorption coefficient (between gas phase and solid phase).

At the outlet of the column a detector is arranged capable of showing the presence of various substances according to the time of permanence in the column. The detector records the motion of the different components and allows analysing them qualitatively and quantitatively. In particular, the gases exit from the column in different times causing the detector to emit a signal having an intensity proportional to their concentration. The signal is then recorded by an instrument that traces a chromatogram, i.e. a curve for evaluating the concentration of the different components. The quantitative analysis of the gaseous mixture is based on the fact that to each component on the chromatogram “a peak value” corresponds that is function of the quantity of substance present, whereby it is possible to calculate the concentration of the different substances by measuring the area under the peaks. This way, it is possible to have both data on the relative quantity of the substances present in a mixture and data on the absolute quantity of each component.

A particularly critical step of the analysis is the calibration of the instrument that consists of tracing a calibration curve, by plotting the areas of the peaks, and that is responsive to the partial pressure of the substance examined. The calibration of the instrument is done by bringing in the column different “standards”, i.e. samples of gas where the partial pressure of the examined gas is known. The data obtained are used for tracing the calibration curve through which the unknown concentration of the solution can be easily calculated.

A concentration exists beyond which the response of the detector is not any more linear.

Normally, an apparatus for gaschromatographic analysis of a gaseous mixture requires many working solutions at different concentrations to obtain a reliable calibration curve. Furthermore, the presently known analysis apparatus that use universal detectors, for example thermoconductivity detectors, have holding limits that are relatively high, and in order to be increased they require a high absolute quantity of the examined component.

### SUMMARY OF THE INVENTION

It is therefore a first feature of the invention to provide an analysis apparatus for gas samples that is capable of analysing samples at the same pressure of the standards, limiting the standardization to a minimum number of experimental points.

It is another feature of the invention to provide such an apparatus that allows determining the pressure in the containers of gaseous samples.

It is also a feature of the invention to provide such an apparatus for analysing a gas present in a sampling mixture in low concentration.

It is a further feature of the invention to provide such an apparatus for sharing the sample among one or more gaschromatographic instruments and for making then multiple analysis at the same time.

These and other features are accomplished with one exemplary apparatus for carrying out a gaschromatographic analysis of a gas sample, according to the present invention, whose main characteristic is to provide a variable volume chamber, said chamber being in fluodynamic connection with a sample holding container, which contains the gas sample, and with a plurality of analytic columns, said variable volume chamber being associated to means for adjusting the volume of said chamber in order to bring the pressure of the gas contained therein at predetermined pressure values before introducing said gas in at least one of said columns.

In particular, the range of predetermined pressures corresponds to pressure values at which the response of the detector associated to each column is linear.

Advantageously, the gas sample at the outlet of the variable volume chamber is mixed to a gas carrier current, for example a current of argon, helion, nitrogen, or hydrogen, suitable for bringing it to at least one analysis column.

Advantageously, the variable volume chamber is associated to means for measuring the pressure inside. This allows monitoring instantly the pressure of the gas sample and stopping the compression/expansion of the gas same when its pressure falls within predetermined pressure ranges. This way, the calibration of the instrument of analysis is simplified and the whole process for gaschromatographic analysis is speeded up. The apparatus, according to the invention, carries out precise analysis in the case of both very low concentration and very high concentration of the gas sample in the gas mixture. In fact, in the latter cases the pressure of the gas sample would not fall within the range of pressure values corresponding to a linear response, or within the sensing range of the detector, and a long and troublesome gaschromatographic analysis would be required. A suitable variation of the volume of the variable volume chamber and then of the pressure of the gas sample present therein solves the problem in a quickly and effective way.

Advantageously, the means for adjusting the volume of said gas chamber comprises a cylinder in which a piston is arranged. In particular, the walls of the cylinder and the piston define the variable volume chamber whose volume is adjusted by the relative movement between the cylinder and the piston.

Alternatively, the means for adjusting the volume of said chamber for the gas sample comprises a variable volume chamber having the walls of flexible material, for example a bellows.

Preferably, the gas sample has a starting pressure comprised in a range between 1 and 1000 millibar.

According to another aspect of the invention, a method for carrying out a gaschromatographic analysis of a gas sample present in a sample holding container provides the following steps:
arranging a gas sample in a variable volume chamber;
reading the pressure in the sample holding container;
adjusting the volume of said variable volume chamber in order to bring the pressure of the gas sample within a predetermined range;
feeding the gas sample at a determined pressure in at least one gaschromatographic instrument.

In particular, at the outlet of the variable volume chamber the gas sample is mixed to a current of a gas carrier suitable for bringing it into the gaschromatographic instrument. The method can be advantageously used for analysing a gaseous mixture containing a determined gas also in traces and then harder to detect such as, for example, helion and argon for geothermal gas analysis, level of air pollution for example in case of carbon monoxide, etc.

### BRIEF DESCRIPTION OF THE DRAWINGS

The invention will now illustrated with the following description of an exemplary embodiment thereof, exemplifying but not limitative, with reference to the attached drawings wherein:

FIG. 1 shows diagrammatically a first exemplary embodiment of an apparatus for a gaschromatographic analysis, according to the invention;

FIG. 2 shows diagrammatically an alternative exemplary embodiment of the apparatus for a gaschromatographic analysis of FIG. 1.

### DESCRIPTION OF A PREFERRED EXEMPLARY EMBODIMENT

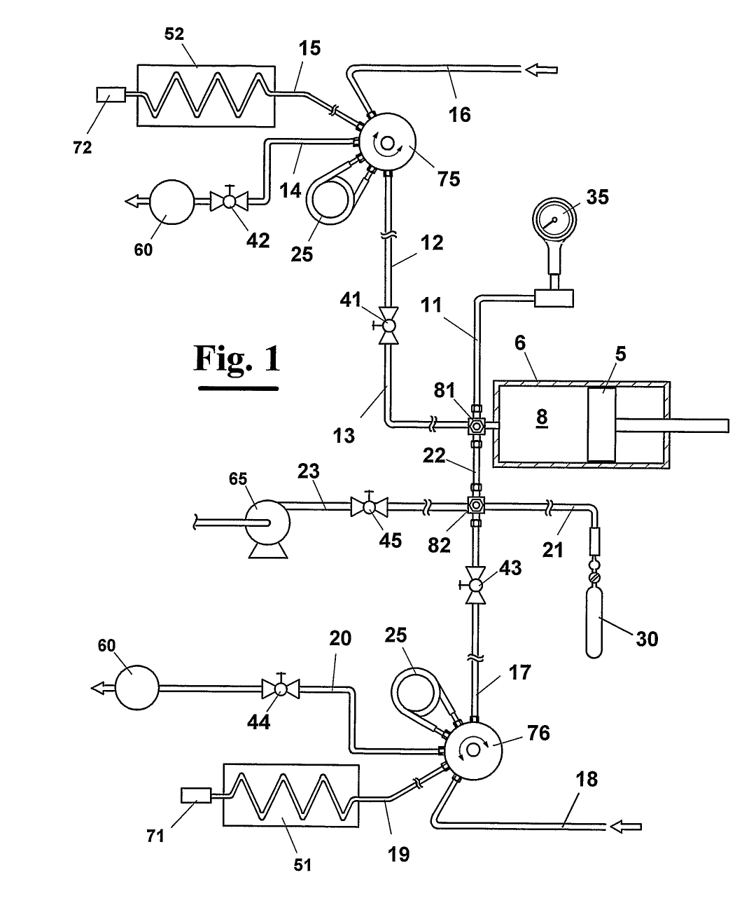

With reference to FIG. 1, a first exemplary embodiment of an apparatus for analysing a gas sample, according to the present invention, comprises a variable volume chamber 8 in fluodynamic connection, through a line 21-22, with a sample holding container 30, in which the gas sample is contained, and through a line 11-19 with a plurality of gaschromatographic instruments, for example two, 51 and 52. These instruments carry out a quantitative and qualitative analysis of the gas sample according to known techniques.

Preliminarily, through vacuum pumps 60, line 11-23 and variable volume chamber 8 are vacuumed. Then valves 41, 43 and 45 are closed in order to exclude portions of line set between valves 41 and 43 and six-way valves 75 and 76 respectively, and the delivery duct 23 of a pump 65 that carries out the general pumping of the line. Since variable volume chamber 8, when it is connected to the sample holding container 30, is in vacuum conditions, it attracts a certain quantity of gas sample inside. The chamber 8 is, furthermore, connected to a pressure sensor 25, for example an analogic reader 35, whereby it is possible to monitor instantly the pressure of the gas sample that has been put in and then in the sample holding container 30.

Once chosen the column 51, or 52, which can be used for carrying out the qualitative and quantitative analysis of the gas sample, corresponding valve 41, or 43, is open. Then, starting from known volume and pressure the gas sample is compressed, or expanded, changing the volume of the chamber 8 in order to bring the pressure of the gas to fall within a predetermined range for which the response of the detector 70, or 71, is linear.

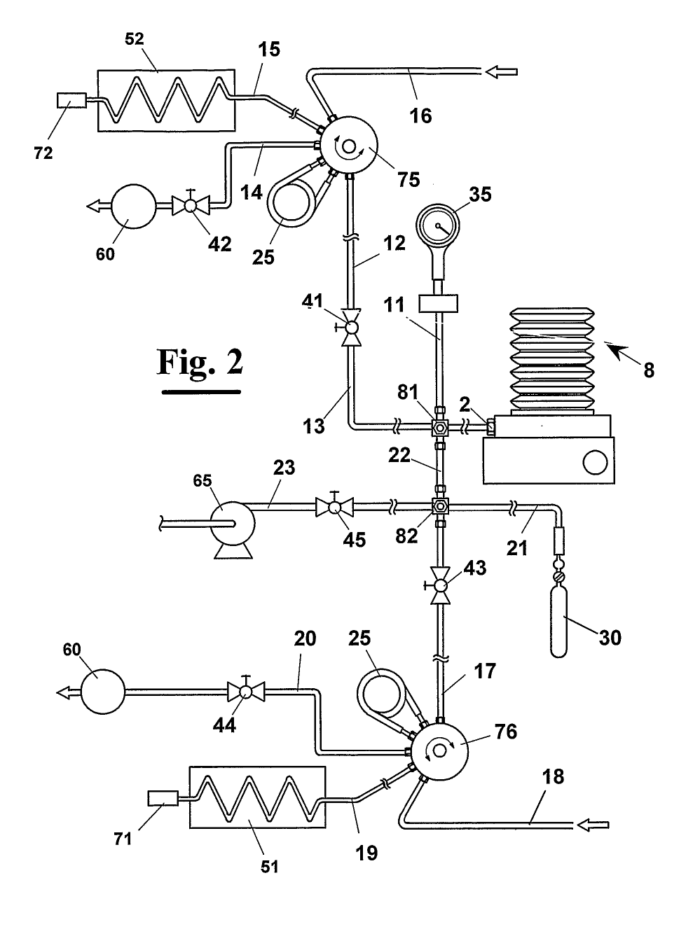

The volume of chamber 8 can be changed, for example, by a piston 5 sliding in a cylinder 6 (FIG. 1), or alternatively, changing the configuration of a container having flexible walls, for example a bellows 101 (FIG. 2). The pressure of the gas sample in chamber 8 is fixedly determined and the compression/depression step of the gas same can be quickly stopped, so that the gas sample has a desired pressure.

At the outlet of variable volume chamber 8 the gas sample, already at the desired pressure, passes through a duct 12, or 17, up to reach a valve, for example a six-way valve, 75, or 76 and then a loop portion 25 of the line. Then the gas sample is brought into the analysis column 51, or 52, chosen for the analysis, by a gas carrier put into valve 75, or 76, through a feeding duct 16, or 18. More in detail, the gas carrier, which can be helion, hydrogen, nitrogen or argon, according to the case, is mixed to the gas sample in six-way valve 75, or 76, and then brings it into column 51, or 52, to it connected.

The calibration of the gas sample pressure within a range of pressures for which there is a linear response by detector 71, or 72, provides a gaschromatographic analysis very precise also in case of starting concentration in the gaseous mixture that is very low, or very high. Detector 71, or 72, as it can be used in the apparatus, can be of specific or universal type, according to the kind of use of the apparatus for analysis.

Furthermore, a further advantage of the apparatus, according to the invention, is to carry out a quantitative and qualitative analysis also on samples of gas at the same pressure of the standard solution, thus speeding up the whole analysis procedure.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. Apparatus for carrying out a gaschromatographic analysis of a gas sample characterised in that it provides a variable volume chamber, said chamber being in fluodynamic connection with a sample holding container, which contains the gas sample, and with a plurality of analytic columns, said variable volume chamber being associated to means for adjusting the volume of said chamber in order to bring the pressure of said gas contained therein at predetermined pressure values before introducing said gas in at least one of said columns.

2. Apparatus, according to claim 1, wherein said range of predetermined pressures corresponds to pressure values at which the response of the detector associated to each column is linear.

3. Apparatus, according to claim 1, wherein said gas sample exiting from said variable volume chamber is mixed to a gas carrier current, suitable for bringing it to at least one analysis column.

4. Apparatus, according to claim 1, wherein said variable volume chamber is associated to means for measuring the pressure inside.

5. Apparatus, according to claim 1, wherein said means for adjusting the volume of said chamber of said gas comprises a cylinder in which a piston is slidingly arranged, said variable volume chamber being defined between said cylinder and said piston, whereby its inner volume changes responsive to the relative position of said piston in said cylinder.

6. Apparatus, according to claim 1, wherein said means for adjusting the volume of said gas sample comprises a variable volume chamber having walls of flexible material, said volume changing according to the configuration of said walls.

7. Apparatus, according to claim 1, wherein said gas sample has a starting pressure comprised in a range between 1 and 1000 millibar.

8. Method for analysing a gas sample present in a sample holding container characterised in that it provides the following steps:
putting the gas sample in a variable volume chamber;
reading the pressure in the sample holding container;
adjusting the volume of said variable volume chamber in order to bring the pressure of said gas sample within a predetermined range;
feeding said gas sample at said determined pressure in at least one gaschromatographic instrument.
